(19) United States
(12) Patent Application Publication
(10) Pub. No.: US 2022/0099246 A1
(43) Pub. Date: Mar. 31, 2022

(54) Display Platform

(71) Applicant: Christophe Obolo, New Milford, NJ (US)

(72) Inventor: Christophe Obolo, New Milford, NJ (US)

(21) Appl. No.: 17/033,569

(22) Filed: Sep. 25, 2020

(51) Int. Cl. F16M 13/02; G09F 13/18; A47G 1/06; G09F 17/00; G09F 7/08

(52) U.S. Cl. CPC F16M 13/02; G09F 13/18; A47G 1/0622; F16M 2200/08; G09F 7/08; G09F 2013/1845; G09F 17/00

(57) ABSTRACT

A platform including: an angular base; a display platform engaged to said angular base, wherein said display platform is configured to engage a border or an edge of a computer monitor or TV screen onto which at least one of a picture frame, an ornamental object, a small office pad or reminder note pad, a set of miniature flags, and a small office item is mounted; a broad band inserted between a superior and a frontal edge of said display platform, wherein said broad band is configured to improve user's visual perception and depth; and means for increasing the visibility of at least one of the objects mounted on said display platform.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to display boards and platforms. More particularly, certain embodiments of the invention relate to a display platform mountable to a horizontal or vertical edge or surface.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In many modern offices and workspaces, a well-organized desk space may increase productivity and provide an individual a larger utilizable area on which to perform essential daily tasks. Computers and computer related peripherals typically utilize a large portion of valuable desk space, leaving little room for displaying personal items, posting reference material, and organizing office supplies. Various organizational tools may be used to increase the efficiency of desktop utilization. However, in many situations, these organizational tools may utilize desk space themselves.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is organizational tools may be mounted to a desktop monitor, avoiding the use of limited desk space. Typical monitor-mounted organizational tools provide a flat surface for displaying pictures, messages, etc. Such organizational tools may only be able to accommodate for items to be mounted on a flat, vertical surface, and may not support three dimensional or bulkier items that an individual may want to display.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1C illustrate an exemplary display platform, in accordance with an embodiment of the present invention, wherein FIG. 1A shows a front view of an exemplary display platform, FIG. 1B shows an alternative extended front platform of an exemplary display platform, and FIG. 1C shows an alternative extended back platform of an exemplary display platform;

FIG. 2 illustrates an exemplary display platform with various available positions, in accordance with an embodiment of the present invention;

FIG. 3 illustrates an exemplary display platform with ornamental flags, in accordance with an embodiment of the present invention;

FIG. 4 illustrates a front view of an exemplary display platform mounted to a computer monitor, in accordance with an embodiment of the present invention;

FIG. 5 illustrates a rear view of an exemplary display platform mounted to a computer monitor, in accordance with an embodiment of the present invention;

FIG. 6 illustrates exemplary display monitors mounted to different locations on a shelf, in accordance with an embodiment of the present invention;

FIG. 7 illustrates an exemplary base for attaching a frame, in accordance with an embodiment of the present invention;

FIG. 8 illustrates an exemplary display platform mounted to different locations on a desk, in accordance with an embodiment of the present invention; and

FIG. 9 illustrates an exemplary display platform, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hollinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

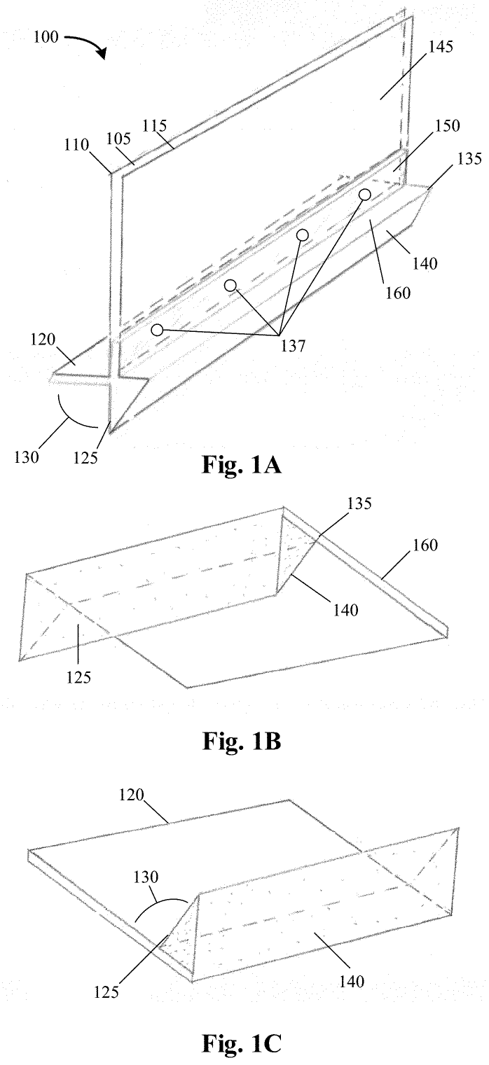

FIGS. 1A-1C illustrate an exemplary display platform, in accordance with an embodiment of the present invention, wherein FIG. 1A shows a front view of an exemplary display platform, FIG. 1B shows an alternative extended front platform of an exemplary display platform, and FIG. 1C shows an alternative extended back platform of an exemplary display platform. Display platform 100 may comprise two main areas for displaying objects and reference material: vertical frame section 145 and platform portion 135. Vertical frame 145 may be used to display, for example, without limitation, photographs, notes, reminders, etc., and may comprise front panel 115 and rear panel 110. Front panel 115 and rear panel 110 may be composed of any durable transparent material, such as but not limited to, acrylic, polycarbonate, glass, etc. to allow flat objects inserted into middle gap 105 created by front panel 115 and rear panel 110 to be visibly displayed. Rear panel 115 may also be composed of sturdy, non-transparent material, such as plastic, wood, aluminum, etc. Optionally, broad band 150 may be attached between platform 135 and vertical frame 145, altering the visual perspective of objects inserted into middle gap 105 by raising the objects away from platform 135. Broad band 150 may be inserted between the superior and frontal edge of the platform and attached objects such as picture frames, miniature flags, etc. to further improve angular separation to maintain visual depth and perception as to make attached objects less bulky and less interfering to the visual fields when a user works on a computer or watches TV. Lighting 137, such as, but not limited to, light emitting diodes (LEDs) may be attached or built into broad band 150, further increasing the visibility of objects inserted into middle gap 105 or placed on platform 135. Further, vertical frame 145 may be removed and holes may be drilled into the top surface of broad band 150 for the storing or displaying of objects, such as, but not limited to, pens, pencils, miniature flags, etc.

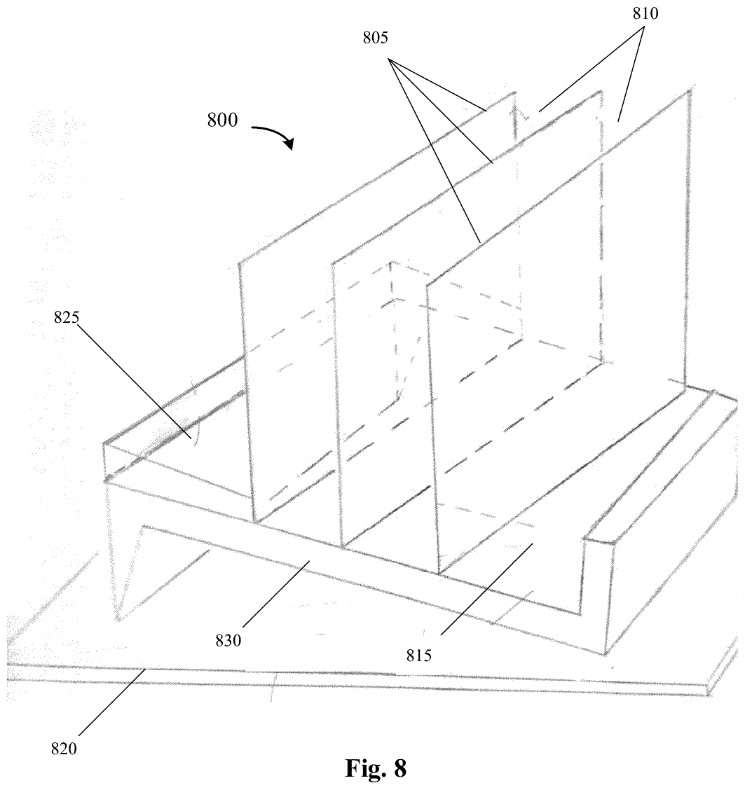

With one or more of broad band 150 or vertical frame 145 attached, platform 135 may be divided into front platform 160, to be used for displaying bulkier or three-dimensional objects, and rear platform 120, which may be used primarily for mounting purposes. Display platform 100 may be attached to edges or other flat surfaces via attachment area 130, comprising the bottom surface of rear platform 120 and rear surface 125. Rear platform 120 and vertical surface 125 may be orthogonal to one another, and may act as a mounting point for display platform 100. Platform 135 may be attached to angular base 140 to provide a visual and structural separation to maintain visual depth and perception and make attached items less bulky, when platform 135, is attached to borders or edges of computer monitors and/or TV screen borders. Picture frames, ornamental objects, small office pads or reminder note pads, may be displayed on the vertical frame, and a set of miniature flags may be mounted on the front or rear platforms. Various mounting means, such as, but not limited to, Velcro, adhesive tape, screws, nails, magnets, slide-and-lock mechanism (FIG. 8), etc. may be used to secure attachment area 130 of display platform 100 to a vertical surface. Additionally, front angular base 140 between rear surface 125 and front platform 160 may provide additional support for platform 135. A small bag may be attached to the rear edge of the platform as storage for small office items such as pens, pencils, markers. In one embodiment, front angular base 140 may form a triangular base for display platform 100, it should be appreciated by one skilled in the art that other angular base 140 may form other shaped bases, such as, but not limited to, triangular, rectangular, semi-circle, etc.

Platform 135 is not limited to being a specific length, and may be longer or shorter depending on the needs of the user. For example, without limitation, front platform 160 may extend past angular base 140 to provide a user with more surface area on which to display bulkier or three-dimensional items, as shown in FIG. 1B. Further, rear platform 120 may have greater length to provide a larger mounting surface and greater stability to display platform 100.

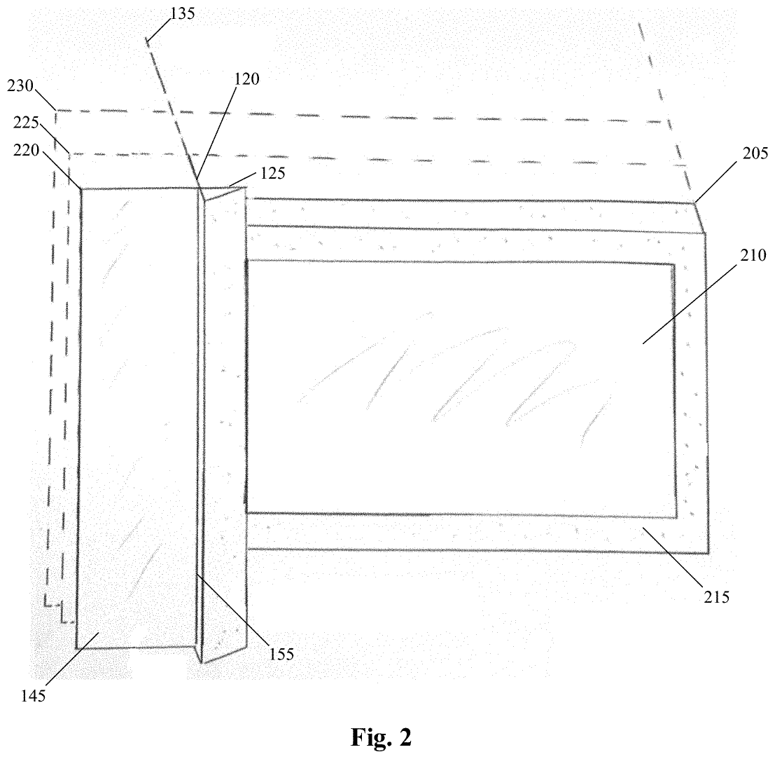

FIG. 2 illustrates an exemplary display platform with various available positions, in accordance with an embodiment of the present invention. With reference to both FIG. 1 and FIG. 2, display platform 100 may be mounted on edge 215 of screen 205, allowing a user to display objects to the side of viewing area 210 of screen 205. Screen 205 may be, for example, without limitation, a computer monitor, television screen, etc. Rear surface 125 and rear platform 120 may be mounted via mounting means to edge 215 of screen 205 to secure display platform 100 to screen 205. Further, vertical frame 145 may be attached in various positions along platform 135 to alter the depth of objects displayed in vertical frame 145. For example, without limitation, vertical frame 145 may be attached to platform 135 at first position 220, second position 225, third position 230, etc.

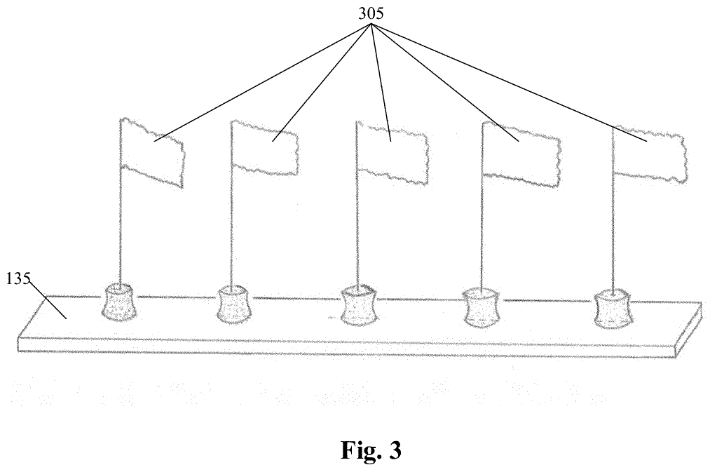

FIG. 3 illustrates an exemplary section view of display platform with ornamental flags, in accordance with an embodiment of the present invention. With reference to both FIG. 1 and FIG. 3, vertical frame 145 (not depicted) may be removed from platform 135 to provide additional space for bulkier or three-dimensional items. Vertical objects with more height such as, without limitation, miniature trees, miniature toys, or ornamental flags 305 may be displayed on platform 135 without being restricted by vertical frame 145. Ornamental flags 305 may comprise miniature flags where the miniature flags are attached to the display platform by miniature poles and miniature vases.

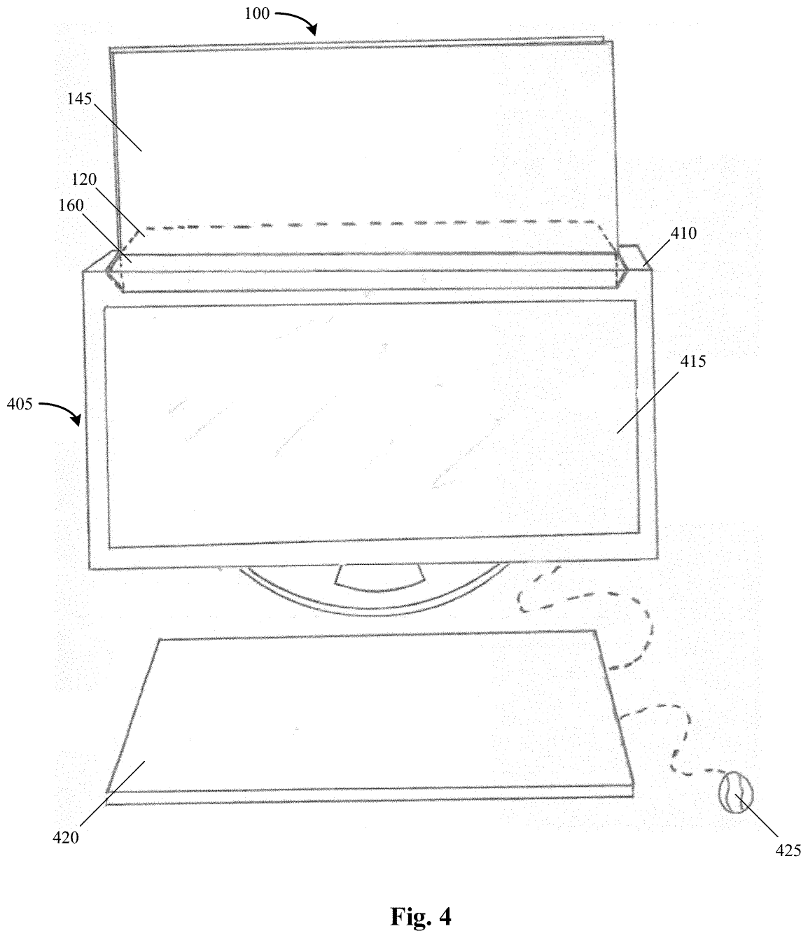

FIG. 4 illustrates a front view of an exemplary display platform mounted to a computer monitor, in accordance with an embodiment of the present invention. With reference to both FIG. 1 and FIG. 4, display platform 100 may also be mounted to the top of a screen, such as top edge 410 of computer monitor 405. This allows for display of objects outside of visual area 415 of computer monitor 405, freeing up desk space for computer peripherals such as, but not limited to, keyboard 420 and mouse 425. While mounted to top edge 410 of computer monitor 405, a user may be able to utilize rear platform 120, front platform 160, and vertical frame 145 to display objects, whereas when mounted in a side position, objects may only easily be displayed in vertical frame 145.

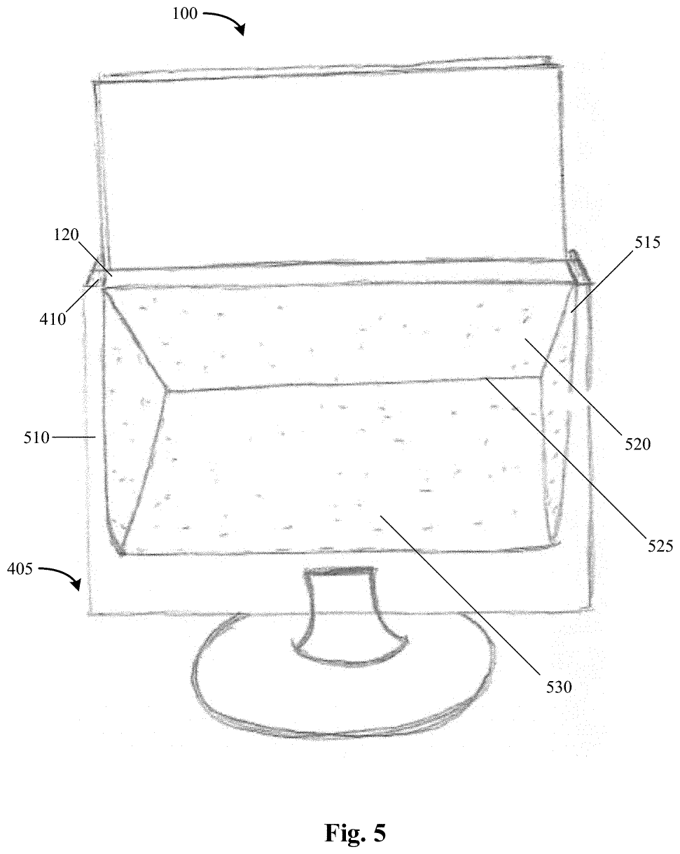

FIG. 5 illustrates a rear view of an exemplary display platform mounted to a computer monitor, in accordance with an embodiment of the present invention. With reference to FIG. 1, FIG. 4, and FIG. 5, display platform 100 may be mounted to top edge 410 of monitor 405 via back/rear platform 120. Further, bag 515 may be attached to rear platform 120 and lie along back panel 510 of monitor 405, allowing for storage of additional objects such as, without limitation, office supplies, computer accessories, etc. Bag implement 515 may be composed of any lightweight material, such as, without limitation, plastic, woven fabric, leather, etc. In some embodiment, top panel 520 may be removed or attached to bag base 530 at bag edge 525 to secure objects within bag 515. Top panel 520 may be secured to bag base 530 by any means known in the art using, for example, without limitation, Velcro, a zipper, fasteners, clasps, etc. Additionally, top panel 520 may be completely removed and objects may be stored in bag 515 without covering. As will be appreciated by one skilled in the art, any appropriately sized and shaped bag may be secured to rear platform 120.

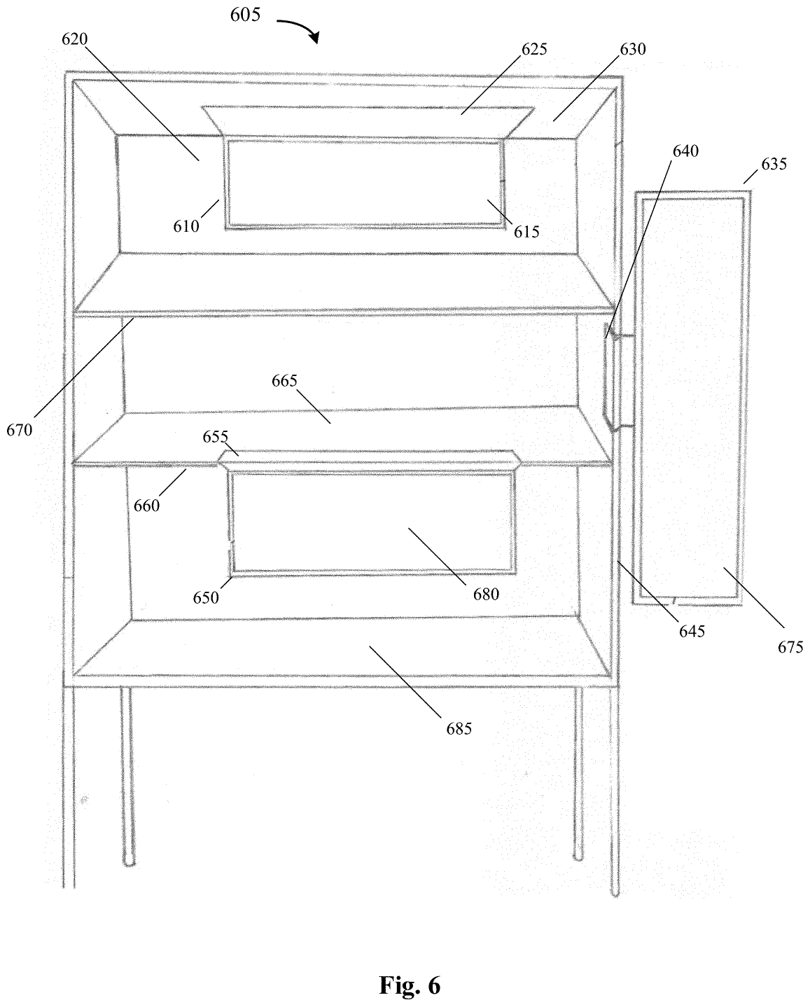

FIG. 6 illustrates exemplary display monitors mounted to different locations on a shelf, in accordance with an embodiment of the present invention. There may be a plurality of different mounting options for display platform 100 on shelving unit 605, depending on the needs of the user. For example, without limitation, first display platform 610 may be mounted to top surface 630 of shelving unit 605, securing first display platform 610 to rear surface 620. To do so, mounting means may be applied between first platform 625 and top surface 630, as well as between rear surface 620 and first vertical frame 615 so that objects displayed in first vertical frame 615 may be behind any objects displayed on first shelf 670. Additionally or alternatively, second display platform 635 may be mounted to side edge 645 of shelving unit 605, allowing for the display of objects in second vertical frame 675. Second platform 640 may be smaller in size to fit in-between first shelf 670 and second shelf 665. A third option is shown by third display platform 650, wherein third display platform 650 may be mounted upside down on second shelf 665. Third display platform 650 may be mounted onto front edge 660 of second shelf 665 via a mounting means between third platform 655 and front edge 660. In the third position, third vertical frame 680 may be used to display objects in front of objects to be displayed on third shelf 685. As will be appreciated by one skilled in the art, additional mounting options other than the three mounting options shown in FIG. 6 may be used for displaying objects using display platform 100, and display platform 100 is not limited to these three options.

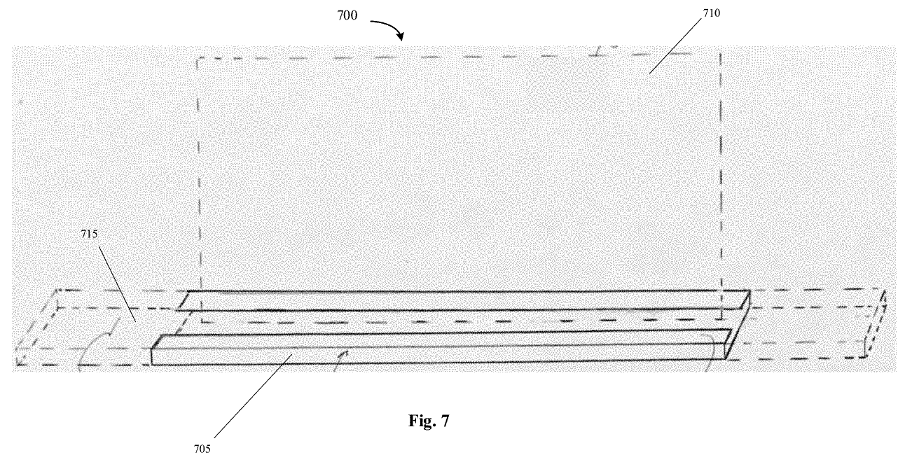

FIG. 7 illustrates an exemplary base for attaching a frame, in accordance with an embodiment of the present invention. In one embodiment, lock base 700 may include open and curved slabs 705 operable for attachment to TV or computer through tape or magnetic stripes. Vertical frame 710 may comprise attachment slab 715 that is configured to slide into the open and curved slabs of the base and locked in place.

FIG. 8 illustrates an exemplary display platform mounted to different locations on a desk, in accordance with an embodiment of the present invention. Platform 800 may be free standing wherein file dividers and small compartments may be mounted to hold personal office items and including storing and charging small electronics such as, but not limited to, iPhones or iPads. Platform 800 may comprise panels 805 configured to create file slots 800, open slot or back pocket 815, iPhone storage and charging pocket 825, and base 830.

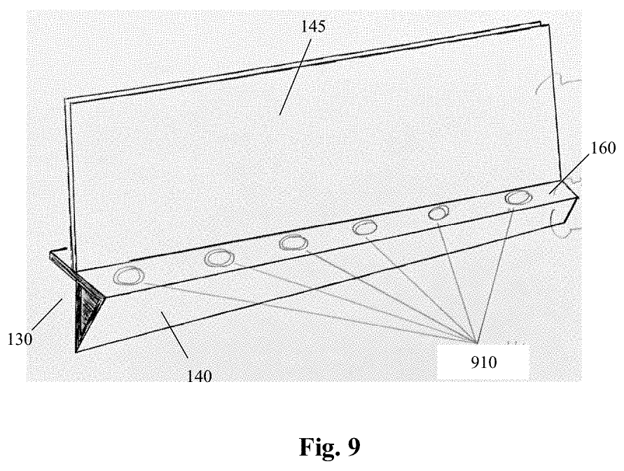

FIG. 9 illustrates an exemplary display platform, in accordance with an embodiment of the present invention. In some embodiment, display platform may comprise of vertical frame 145, front platform 160, LED lights 910, angular base 140, and attachment area 130. LED lights 910 maybe mounted on the anterior or frontal surface of angular base 140 of front platform 160, when a broadband is not present, increasing the visibility of objects inserted into the middle gap of vertical frame 145 or placed on front platform 160.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a display platform according to the present invention will be apparent to those skilled in the art. Various aspects of the invention have been described above by way of illustration, and the specific embodiments disclosed are not intended to limit the invention to the particular forms disclosed. The particular implementation of the display platform may vary depending upon the particular context or application. By way of example, and not limitation, the display platform described in the foregoing were principally directed to object display implementations; however, similar techniques may instead be applied to secondary screen mounting, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre AIA) or 35 USC 112(f) post-AIA. Otherwise, no limitations from the specification are to be read into any claims, unless those limitations are expressly included in the claims.

What is claimed is:

1. A platform comprising:
an angular base;
a display platform engaged to said angular base, wherein said display platform is configured to engage a border or an edge of a computer monitor or TV screen onto and further configured to be operable to support suitably small objects;
a broad band inserted between a superior and a frontal edge of said display platform, wherein said broad band is configured to improve user's visual perception and depth;
means for displaying or signaling information or lighting effects; and
means for increasing the visibility of at least one of the objects mounted on said display platform.

2. The platform of claim 1, further comprising an attachment area that is configured to be operable for attaching said display platform on the border or edge of the computer monitor or TV screen.

3. The platform of claim 2, wherein said broad band is configured to improve angular separation to maintain visual depth and perception as to make attached objects less bulky and less interfering to visual fields when working on a computer or watching TV.

4. The platform of claim 3, further comprises a rear platform.

5. The platform of claim 4, further comprises a rear surface of said angular base.

6. The platform of claim 5, in which said attachment area comprises a bottom surface of said rear platform and rear surface of said angular base.

7. The platform of claim 6, further comprising a vertical frame, in which said vertical frame comprises at least a front panel and a rear panel.

8. The platform of claim 7, in which said display platform comprises a front platform and a back platform.

9. The platform of claim 8, in which said visibility increasing means is built within said broad band;

10. The platform of claim 8, in which said visibility increasing means is mounted on at least one of, an anterior and a frontal surface of said angular base.

11. The platform of claim 10, further comprising a middle gap created by said front panel and rear panel, wherein said middle gap is configured to be operable for accepting and displaying flat objects.

12. The platform of claim 1, in which said suitable small objects comprise a picture frame, an ornamental object, a small pad, generally vertically oriented objects that standing generally upward thereupon said angular base, miniature flags engaging said angular base, miniature trees, miniature toys, and/or small office items.

13. The platform of claim 12, in which said bag implement further comprises a bag base.

14. The platform of claim 13, in which said bag implement further comprises a bag edge.

15. A display platform comprising:
means for holding at least one of, a photograph, a picture frame, a note, and a reminder;
means for mounting said holding means on an edge or border of a computer monitor or TV screen;
means for accepting flat objects, in which said accepting means is created by said holding means;
means for displaying bulkier or three-dimensional objects;
means for displaying or signaling information or lighting effects;
means for increasing a visibility of the objects placed on said object displaying means; and
means for attaching said displaying means on the edge or border of the computer monitor or TV screen.

16. A display platform comprising:
an angular base, said angular base is configured to engage at least one of, a photograph, a picture frame, a miniature flag, and a small office item;
a platform portion, said platform is into an engagement with said angular base where said platform is configured to attach to borders or edges of computer monitors or TV screen;
a broad band, said broad band is inserted between a superior and a frontal edge of said platform; and
one of more LED lights built are attached or built within said broad band.

17. The display platform of claim 16, further comprising:
a vertical frame, in which said vertical frame comprises at least a front panel and a rear panel;
a middle gap formed by said front panel and rear panel, said middle gap is configured to accept flat objects;
in which said platform portion comprises a rear platform;
an attachment area, in which said attachment area comprises a bottom surface of said rear platform and rear surface of said angular base.

18. The display platform of claim 17, further comprising a bag implement engaged at a rear edge of said platform portion, wherein said bag implement is configured as storage for small office items including pens, pencils, or markers.

19. The display platform of claim 17, in which said one or more LED lights are configured to be operable for increasing the visibility of at least one of the objects mounted on said platform portion.

20. The display platform of claim 17, in which said one or more LED lights are mounted on at least one of an anterior and a frontal surface of said angular base.
